(19) United States
(12) Patent Application Publication
(10) Pub. No.: US 2012/0301705 A1
(43) Pub. Date: Nov. 29, 2012

(54) NANOWIRE COATINGS, FILMS, AND ARTICLES

(76) Inventor: Karissa L. Eckert, Blaine, MN (US)

(21) Appl. No.: 13/421,058

(22) Filed: Mar. 15, 2012

Related U.S. Application Data
(60) Provisional application No. 61/488,852, filed on May 23, 2011.

(51) Int. Cl. C09D 133/16; B32B 5/30; C09D 101/14

(52) U.S. Cl. 428/317.9; 106/122; 521/50; 521/142

(57) ABSTRACT

Coatings are disclosed comprising cellulosic polymers, silver nanowires, and surfactants that exhibit resistivities less than about 150 ohms per square and void densities less than about ⅜ voids per square inch. Such coatings and transparent films made from such coatings are useful in electronics applications.

### CROSS REFERENCE TO RELATED APPLICATIONS

This application claims the benefit of U.S. Provisional Application No. 61/488,852, filed May 23, 2012, entitled NANOWIRE COATINGS, FILMS, AND ARTICLES, which is hereby incorporated by reference in its entirety.

### SUMMARY

At least a first embodiment provides coatings comprising a first amount of at least one cellulosic polymer; a second amount of silver nanowires, where the ratio of the second amount to the first amount is between about 0.1 and about 1; and a third amount of at least one surfactant comprising at least one of a an anionic fluorosurfactant or a polymer comprising at least one fluorine atom, where the ratio of the third amount to the first amount is between about 0.001 and about 1, and where the coating has a resistivity less than about 150 ohms per square and a void density less than about ⅜ voids per square inch. In at least some embodiments, the at least one cellulosic polymer may comprise at least one cellulose ester or cellulose ether, or the at least one cellulosic polymer may comprise at least one cellulose ester. Cellulose acetate butyrate is an exemplary cellulosic polymer. In at least some embodiments, at least some of the silver nanowires have lengths greater than about 10 μm and diameters less than about 140 nm, or the nanowires may have lengths greater than about 10 μm and less than about 50 μm. In at least some embodiments, the at least one surfactant comprises at least one of FLEXIPEL™ AM-101 partially fluorinated polymer, ZONYL® 9361 fluorosurfactant, CAPSTONE® FS-63 fluorosurfactant, or MASURF® FP-815CP anionic fluoroacrylate copolymer. In some cases, the at least one surfactant may comprise at least one of partially fluorinated copolymer or an anionic fluorosurfactant, such as, for example, at least one of FLEXIPEL™ AM-101 partially fluorinated polymer, ZONYL® 9361 fluorosurfactant, or CAPSTONE® FS-63 fluorosurfactant. In at least some embodiments, the ratio of the second amount to the first amount is greater than about 0.2 and less than about 0.8. In at least some embodiments, the ratio of the third about to the first about is greater than about 0.002 and less than about 0.05. In at least some embodiments, the coatings have resistivities of less than about 100 ohms per square, or greater than about 72 ohms per square and less than about 99 ohms per square. In at least some embodiments, the coatings have void densities less than about 1/16 voids per square inch, or less than about 1/80 voids per square inch.

At least a second embodiment provides coatings comprising a first amount of at least one polymer, a second amount of silver wires, and a third amount of at least one surfactant, where the ratio of the second amount to the first amount is between about 0.1 and about 1, where the ratio of the third amount to the first amount is between about 0.001 and about 0.1, and where the coating has a resistivity less than about 150 ohms per square and a void density less than about ⅜ voids per square inch. In at least some embodiments, the at least one polymer comprises at least one cellulosic polymer, such as, for example, a cellulose ester or cellulose ether. Cellulose acetate butyrate is an exemplary cellulose ester. In at least some embodiments, at least some of the silver nanowires have lengths greater than about 10 μm and diameters less than about 140 nm, or the nanowires may have lengths greater than about 10 μm and less than about 50 μm, or the nanowires may have diameters greater than about 80 nm and less than about 140 nm. In at least some embodiments, the at least one surfactant comprises at least one partially fluorinated polymer or a fluorosurfactant, such as, for example, FLEXIPEL™ AM-101 partially fluorinated polymer, ZONYL® 9361 fluorosurfactant, or CAPSTONE® FS-63 fluorosurfactant. In at least some embodiments, the ratio of the second amount to the first amount is greater than about 0.2 and less than about 0.8. In at least some embodiments, the ratio of the third about to the first about is greater than about 0.002 and less than about 0.05. In at least some embodiments, the coatings have resistivities of less than about 100 ohms per square, or greater than about 72 ohms per square and less than about 99 ohms per square. In at least some embodiments, the coatings have void densities less than about 1/16 voids per square inch, or less than about 1/80 voids per square inch.

Still other embodiments provide films comprising coatings according to the above embodiments and transparent substrates, where the coatings are disposed on the transparent substrates. In at least some embodiments, such films have visible light transmittance greater than about 86 percent.

Other embodiments provide articles comprising such film, such as, for example, electronic devices.

These embodiments and other variations and modifications may be better understood from the description, exemplary embodiments, examples, and claims that follow. Any embodiments provided are given only by way of illustrative example. Other desirable objectives and advantages inherently achieved may occur or become apparent to those skilled in the art. The invention is defined by the appended claims.

### DESCRIPTION

All publications, patents, and patent documents referred to in this document are incorporated by reference herein in their entirety, as though individually incorporated by reference.

U.S. Provisional Application No. 61/488,852, filed May 23, 2012, entitled NANOWIRE COATINGS, FILMS, AND ARTICLES, is hereby incorporated by reference in its entirety.

Metal nanowire based transparent conductive films have attracted great attention recently due to their excellent electric conductivity, high light transmittance, and easy manufacturing on flexible substrates. Transparent conductive films prepared through networking of silver nanowires have the potential to replace indium tin oxide as transparent conductors in many applications. Transparent conductive films prepared from silver nanowires in an organic binder material could show resistivities of less than about 20 ohm/sq with larger than 86% visible transmittance when coated on PET supports. Such resistivities may be measured using, for example, an R-CHEK™ RC2175 four-point resistivity meter. Such visible transmittance may be measured according the methods of ASTM D1003.

Beyond their aesthetic detraction, coating defects can also adversely affect the conductivity of films. Such defects can break the network of silver nanowires locally, decreasing overall conductivity. In severe cases, such defects may practically eliminate conductivity in the film. Such defects may include voids, where the silver nanowires do not wet out in the coating. These voids are also often circular or oval in their cross-section, with no silver nanowires in their interior.

Surfactants have been used in nanowire coatings. See, for example, US patent publications 2007/0074316, 2009/0129004, 2010/0272993, and 2010/0243295. However, when used in coatings that contain silver nanowires, many surfactants adversely affect conductivity of the coating. Without wishing to be bound by theory, it is believed that these surfactants may coat the nanowires and act as insulators.

The Applicant has discovered that certain surfactants comprising at least one of an anionic fluorosurfactant or a polymer comprising at least one fluorine atom exhibit the ability to wet out silver nanowires, while still allowing a coating surface resistivity of less than about 150 ohms per square to be retained. Exemplary surfactants are FLEXIPEL™ AM-101 partially fluorinated polymer, ZONYL® 9361 anionic fluorosurfactant, CAPSTONE® FS-63 anionic fluorosurfactant, and MASURF® FP-815CP anionic fluoroacrylate copolymer. Some embodiments provide coatings comprising at least one partially fluorinated polymer or a fluorosurfactant, such as, for example, FLEXIPEL™ AM-101 partially fluorinated polymer, ZONYL® 9361 fluorosurfactant, or CAPSTONE® FS 63 fluorosurfactant.

Some embodiments provide coatings comprising at least one cellulosic polymer, or at least one cellulosic polymer comprising at least one cellulose ester, such as, for example, cellulose acetate butyrate. Cellulosic polymers are polysaccharides or derivatives of polysaccharides, that may have degrees of polymerization of, for example, 100, 1000, 10,000, or more. These include derivatives of cellulose, such as, for example, esters and ethers of cellulose. Cellulosic esters include cellulose acetates, such as, for example, cellulose acetate, cellulose triacetate, cellulose propionate, cellulose acetate propionate, cellulose acetate butyrate (CAB), and the like. Cellulosic ethers include, for example, methylcellulose, ethylcellulose, ethyl methyl cellulose, hydroxyethyl cellulose, hydroxypropyl cellulose, hydroxyethyl methyl cellulose, hydroxypropyl methyl cellulose, ethyl hydroxyethyl cellulose, carboxymethyl cellulose, and the like. These and other such cellulosic polymers will be understood by those skilled in the art.

Some embodiments provide coatings comprising silver nanowires. The general preparation of silver nanowires (10-200 aspect ratio) is known. See, for example, Angew. Chem. Int. Ed. 2009, 48, 60, Y. Xia, Y. Xiong, B. Lim, S. E. Skrabalak, which is hereby incorporated by reference in its entirety. Nanowires are one-dimensional nanostructures in which the two short dimensions (the thickness dimensions) are less than 300 nm, preferably less than 100 nm, while the third dimension (the length dimension) is greater than 1 micron, preferably greater than 10 microns, and the aspect ratio (ratio of the length dimension to the larger of the two thickness dimensions) is greater than five. Nanowires are being employed as conductors in electronic devices or as elements in optical devices, among other possible uses. Silver nanowires are preferred in some such applications.

### EXEMPLARY EMBODIMENTS

U.S. Provisional Application No. 61/488,852, filed May 23, 2012, entitled NANOWIRE COATINGS, FILMS, AND ARTICLES, which is hereby incorporated by reference in its entirety, disclosed the following 18 non-limiting exemplary embodiments:

A. A coating comprising:

a first amount of at least one polymer;

a second amount of silver nanowires, the ratio of the second amount to the first amount being between about 0.1 and about 1; and

a third amount of at least one surfactant, the ratio of the third amount to the first amount being between about 0.001 and about 0.1,

wherein the coating has a resistivity less than about 150 ohms per square and a void density less than about ⅜ voids per square inch.

B. The coating according to embodiment A, wherein the at least one polymer comprises at least one cellulosic polymer.
C. The coating according to embodiment A, wherein the at least one polymer comprises at least one cellulose ester or cellulose ether.
D. The coating according to embodiment A, wherein the at least one polymer comprises cellulose acetate butyrate.
E. The coating according to embodiment A, wherein at least some of the silver nanowires have lengths greater than about 10 μm and diameters less than about 140 nm.
F. The coating according to embodiment A, wherein the silver nanowires have lengths greater than about 10 μm and less than about 50 μm.
G. The coating according to embodiment A, wherein the silver nanowires have diameters greater than about 80 nm and less than about 140 nm.
H. The coating according to embodiment A, wherein the at least one surfactant comprises at least one of a partially fluorinated polymer or a fluorosurfactant.
J. The coating according to embodiment A, wherein the at least one surfactant comprises at least one of FLEXIPEL™ AM-101 partially fluorinated polymer, ZONYL® 9361 fluorosurfactant, or CAPSTONE® FS-63 fluorosurfactant.
K. The coating according to embodiment A, wherein the ratio of the second amount to the first amount about is greater than about 0.2 and less than about 0.8.
L. The coating according to embodiment A, wherein the ratio of the third amount to the first amount about is greater than about 0.002 and less than about 0.05.
M. The coating according to embodiment A, wherein the coating has a resistivity less than about 100 ohms per square.
N. The coating according to embodiment A, wherein the coating has a resistivity greater than about 72 ohms per square and less than about 99 ohms per square.
P. The coating according to embodiment A, wherein the coating has a void density less than about 1/16 voids per square inch.
Q. The coating according to embodiment A, wherein the coating has a void density less than about 1/80 voids per square inch.
R. A film comprising the coating according to embodiment A and a transparent substrate, wherein the coating is disposed on the transparent substrate.
S. The film according to embodiment R, wherein the film has a transparency greater than about 86 percent.
T. An article comprising the film according to embodiment R.

### EXAMPLES

### Materials

Unless otherwise noted, materials were available from Sigma-Aldrich, Milwaukee, Wis.

CAB171-15 is a cellulose acetate butyrate polymer (Eastman Chemical).

CAPSTONE® FS-63 is an anionic fluorosurfactant (Dupont).

DESMODUR® BL3370MPA is a blocked aliphatic polyisocyanate (Bayer).

FLEXIPEL™ AM-101 is a nonionic partially fluorinated polymer (ICT).

FLUORAD® FC-4430 is a nonionic fluorosurfactant (3M).

LAROSTAT® 264A is a cationic quaternary ammonium compound (BASF).

LAROSTAT® 377 DPG is a cationic mixture of n-alkyl dimethyl ethyl ammonium ethyl sulfates in dipropylene glycol (BASF).

MASURF® FP-815CP is an anionic fluoroacrylate copolymer solution. (Mason Chemical).

MASURF® FS-910 is a nonionic fluoroacrylate copolymer solution (Mason Chemical).

TEGO® GLIDE 410 is a polyether modified polysiloxane (Evonik Tego Chemie).

THETAWET™ FS-8000 is a nonionic fluorinated polymer (ICT).

THETAWET™ FS-8100 is a nonionic fluorinated polymer (ICT).

ZONYL® FS-300 is a nonionic fluorosurfactant (Dupont).

ZONYL® FSH is a nonionic fluorosurfactant (Dupont).

ZONYL® 9361 is an anionic fluorosurfactant (Dupont).

### Example 1

6.0 g of cellulose acetate butyrate polymer (CAB171-15, Eastman Chemical), 144.0 g of methyl acetate, and 0.03 g of phthalazone were mixed to form Solution A.

10.0 g of Solution A, 0.10 g of hexamethylene diisocyanate trimer, 0.04 g of bismuth neodecanoate, 22.50 g of ethyl lactate, 15.0 g of isopropanol, and 5.00 g of methyl ethyl ketone (MEK) were mixed to form Solution B.

Solutions of surfactants in MEK were prepared, so as to provide approximately 0.1 wt % of the active surfactant in each solution. Each of these nominal 0.1 wt % surfactant solutions was added to a mixture of 0.16 g of a nominal 2.5 wt % dispersion of silver nanowires in 2-propanol and 1.49 g of Solution B, to provide the surfactant to cellulosic polymer ratios shown in Table I. The resulting dispersions were mixed on a low speed shaker for 5 min and then coated on 7-mil polyethylene terephthalate supports using a #10 Mayer rod. The resulting coatings were dried in an oven at 104° C. for 5 min to provide 8 in×10 in transparent films.

Each of the transparent films was inspected visually and the number of voids per 80 sq. in. was counted. Surface resistivities of the films were also measured using an R-CHEK™ RC2175 four-point resistivity meter. These results are summarized in Table I. Only coated films 1-16 and 1-17, containing FLEXIPEL™ AM-101 partially fluorinated polymer, and coated film 1-18, containing ZONYL® 9361 fluorosurfactant, exhibited both no void defects and surface resistivities less than 150 ohms per square.

TABLE I

| | | Surfactant | Initial | Number of |
|---|---|---|---|---|
| | | to Polymer | Resistivity | Voids per |
| ID | Surfactant | Wt Ratio | (ohms/sq.) | 80 sq. in. |
| 1-1 | None | 0 | 93.8 | >20 |
| 1-2 | ZONYL FS-300 | 0.0025 | 385.0 | >20 |
| 1-3 | ZONYL FS-300 | 0.030 | 1148.0 | >20 |
| 1-4 | FLUORAD FC-4430 | 0.0025 | 397.0 | >20 |
| 1-5 | FLUORAD FC-4430 | 0.030 | 1235.8 | >20 |
| 1-6 | LAROSTAT 264A | 0.0025 | 251.5 | >20 |
| 1-7 | LAROSTAT 264A | 0.030 | 1697.3 | >20 |
| 1-8 | ZONYL FSH | 0.0025 | 1084.5 | >20 |
| 1-9 | ZONYL FSH | 0.030 | 392.5 | >20 |
| 1-10 | LAROSTAT 377 DPG | 0.0025 | 254.5 | >20 |
| 1-11 | LAROSTAT 377 DPG | 0.030 | 475.8 | >20 |
| 1-12 | MASURF FS-910 | 0.0025 | 264.3 | >20 |
| 1-13 | MASURF FS-910 | 0.030 | 1667.3 | >20 |
| 1-14 | MASURF FP-815CP | 0.005 | 855.8 | 9 |
| 1-15 | MASURF FP-815CP | 0.020 | 128.0 | 6 |
| 1-16 | FLEXIPEL AM-100 | 0.005 | 98.5 | 0 |
| 1-17 | FLEXIPEL AM-100 | 0.010 | 72.3 | 0 |
| 1-18 | ZONYL 9361 | 0.030 | 98.5 | 0 |

### Example 2

5.0 g of Solution A of Example 1, 0.09 g of a blocked aliphatic polyisocyanate (DESMODUR® BL3370MPA, Bayer), 0.03 g of bismuth neodecanoate, 16.87 g of ethyl lactate, 11.82 g of isopropanol, 5.00 g of MEK, and 0.3 g of a nominal 2 wt % solution of a polyether modified polysiloxane (TEGO® GLIDE 410, Evonik Tego Chemie) in MEK were mixed to form Solution C.

Solutions of surfactants in MEK were prepared, so as to provide approximately 0.1 wt % of the active surfactant in each solution. Each of these nominal 0.1 wt % surfactant solutions was added to a mixture of 0.08 g of a nominal 2.5 wt % dispersion of silver nanowires in 2-propanol and 0.74 g of Solution C, to provide the surfactant to cellulosic polymer ratios shown in Table II. The resulting dispersions were mixed on a low speed shaker for 5 min and then coated on 7-mil polyethylene terephthalate supports using a #10 Mayer rod. The resulting coatings were dried in an oven at 104° C. for 5 min to provide 8 in×10 in transparent films.

Each of the transparent films was inspected visually and the number of voids per 80 sq. in. was counted. Surface resistivities of the films were also measured using an R-CHEK™ RC2175 four-point resistivity meter. These results are summarized in Table II. Only coated films 2-6 and 2-7, containing CAPSTONE® FS-63 anionic fluorosurfactant, exhibited both few void defects and surface resistivities less than 150 ohms per square.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

TABLE II

| | | Surfactant | Initial | Number of |
|---|---|---|---|---|
| | | to Polymer | Resistivity | Voids per |
| ID | Surfactant | Wt Ratio | (ohms/sq.) | 80 sq. in. |
| 2-1 | None | 0 | 149.75 | >30 |
| 2-2 | THETAWET FS-8100 | 0.01 | 69 | 26 |
| 2-3 | THETAWET FS-8100 | 0.100 | 119.75 | 22 |
| 2-4 | THETAWET FS-8000 | 0.030 | 68.5 | 22 |
| 2-5 | THETAWET FS-8000 | 0.060 | 85.5 | >30 |
| 2-6 | CAPSTONE FS-63 | 0.005 | 128.3 | 2 |
| 2-7 | CAPSTONE FS-63 | 0.050 | 136.8 | 5 |

What is claimed:

1. A coating comprising:
a first amount of at least one cellulosic polymer;
a second amount of silver nanowires, the ratio of the second amount to the first amount being between about 0.1 and about 1; and
a third amount of at least one surfactant comprising at least one of an anionic fluorosurfactant or a polymer comprising at least one fluorine atom, the ratio of the third amount to the first amount being between about 0.001 and about 1,
wherein the coating has a resistivity less than about 150 ohms per square and a void density less than about ⅜ voids per square inch.

2. The coating according to claim 1, wherein the at least one cellulosic polymer comprises at least one of a cellulose ester.

3. The coating according to claim 1, wherein the at least one cellulosic polymer comprises cellulose acetate butyrate.

4. The coating according to claim 1, wherein at least some of the silver nanowires have lengths greater than about 10 μm and diameters less than about 140 nm.

5. The coating according to claim 1, wherein at least some of the silver nanowires have lengths greater than about 10 μm and less than about 50 μm.

6. The coating according to claim 1, wherein the at least one surfactant comprises at least one of FLEXIPEL™ AM-101 partially fluorinated polymer, ZONYL® 9361 fluorosurfactant, CAPSTONE® FS-63 fluorosurfactant, or MASURF® FP-815CP anionic fluoroacrylate copolymer.

7. The coating according to claim 1, wherein the at least one surfactant comprises at least one of an anionic fluorosurfactant or a partially fluorinated copolymer.

8. The coating according to claim 1, wherein the at least one surfactant comprises at least one of FLEXIPEL™ AM-101 partially fluorinated polymer, ZONYL® 9361 fluorosurfactant, or CAPSTONE® FS-63 fluorosurfactant.

9. The film comprising the coating according to claim 1 and a transparent substrate, wherein the coating is disposed on the transparent substrate.

10. The film according to claim 9 comprising a visible light transmittance greater than about 86 percent.
